(19) United States
(12) Patent Application Publication
(10) Pub. No.: US 2025/0156086 A1
(43) Pub. Date: May 15, 2025

(54) DEVICE PERMISSIONS TABLE DEFINING PERMISSIONS INFORMATION FOR A TRANSLATED ACCESS REQUEST

(71) Applicant: Arm Limited, Cambridge (GB)

(72) Inventors: Alexander Donald Charles Chadwick, Cambridge (GB); Yuval Elad, Cambridge (GB)

(73) Assignee: Arm Limited, Cambridge (GB)

(21) Appl. No.: 18/848,830

(22) PCT Filed: Dec. 20, 2022
(86) PCT No.: PCT/GB2022/053315

§ 371 Date: Sep. 19, 2024

(30) Foreign Application Priority Data
Mar. 28, 2022 (GB) 2204353.3

(51) Int. Cl. G06F 3/06; G06F 12/1009

(52) U.S. Cl. CPC G06F 3/0622; G06F 3/0637; G06F 3/067; G06F 12/1009

(57) ABSTRACT

Apparatus, method and code for fabrication of an apparatus. The apparatus comprises address translation circuitry (116) to translate virtual addresses to physical addresses in response to advance address translation requests issued by devices (105) on behalf of software contexts (125). The apparatus also comprises translated access control circuitry (117) to control access to memory (110) in response to translated access requests issued by the devices (105) on behalf of the software contexts (125), based on permissions information defined in a device permission table (220), wherein the corresponding access permissions provide information for checking whether translated access requests from a plurality of software contexts are prohibited.

The present technique relates to the field of data processing systems.

Some data processing systems support advance address translation, in which a requester device issues an advance address translation request specifying a given virtual address (VA), and address translation circuitry translates the virtual address into a corresponding physical address (PA) that is provided back to the requester device. The requester device can subsequently issue translated access requests specifying the physical address, which can be serviced more quickly than if the virtual address was specified, since the address does not need to be translated at the time of issuing the translated access request, as it was already translated previously when the advance address translation request was sent.

Viewed from a first example of the present technique, there is provided an apparatus comprising:
address translation circuitry configured to translate, in response to an advance address translation request issued by a requester device on behalf of a given software context and specifying a given virtual address, the given virtual address into a given physical address and to provide the given physical address to the requester device to be associated with a subsequent translated access request issued by the requester device; and
translated access control circuitry responsive to a translated access request issued by the requester device on behalf of the given software context and specifying a target physical address, to:
   look up, based on the target physical address, corresponding permissions information indicative of corresponding access permissions defined in a device permission table for a region of physical address space encompassing the target physical address, wherein the corresponding access permissions provide information for checking whether translated access requests from a plurality of software contexts are prohibited;
   determine, based on the corresponding permissions information, whether the given software context is prohibited from accessing a target memory location corresponding to the target physical address in response to translated access requests; and
   when it is determined that the given software context is prohibited from accessing the target memory location in response to translated access requests, trigger an error response.

Viewed from another example of the present technique, there is provided a method comprising:
in response to an advance address translation request issued by a requester device on behalf of a given software context and specifying a given virtual address, translating the given virtual address into a given physical address and providing the given physical address to the requester device to be associated with a subsequent translated access request issued by the requester device; and
in response to a translated access request, issued by the requester device on behalf of the given software context and specifying a target physical address, translated access control circuitry performing steps of:
   looking up, based on the target physical address, corresponding permissions information indicative of corresponding access permissions defined in a device permissions table for a region of physical address space encompassing the target physical address, wherein the corresponding access permissions provide information for checking whether translated access requests from a plurality of software contexts are prohibited;
   determining, based on the corresponding permissions information, whether the given software context is prohibited from accessing a target memory location corresponding to the target physical address in response to translated access requests; and
   when it is determined that the given software context is prohibited from accessing the target memory location in response to translated access requests, triggering an error response.

Viewed from another example of the present technique, there is provided a computer-readable medium to store computer-readable code for fabrication of an apparatus comprising:
address translation circuitry configured to translate, in response to an advance address translation request issued by a requester device on behalf of a given software context and specifying a given virtual address, the given virtual address into a given physical address and to provide the given physical address to the requester device to be associated with a subsequent translated access request issued by the requester device; and
translated access control circuitry responsive to a translated access request issued by the requester device on behalf of the given software context and specifying a target physical address, to:
   look up, based on the target physical address, corresponding permissions information indicative of corresponding access permissions defined in a device permission table for a region of physical address space encompassing the target physical address, wherein the corresponding access permissions provide information for checking whether translated access requests from a plurality of software contexts are prohibited;
   determine, based on the corresponding permissions information, whether the given software context is prohibited from accessing a target memory location corresponding to the target physical address in response to translated access requests; and
   when it is determined that the given software context is prohibited from accessing the target memory location in response to translated access requests, trigger an error response.

Further aspects, features and advantages of the present technique will be apparent from the following description of examples, which is to be read in conjunction with the accompanying drawings, in which:

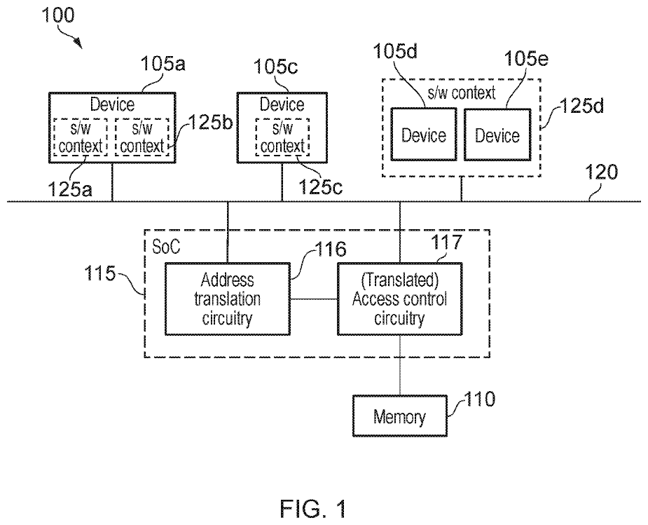

FIG. 1 illustrates a plurality of devices sharing access to memory;

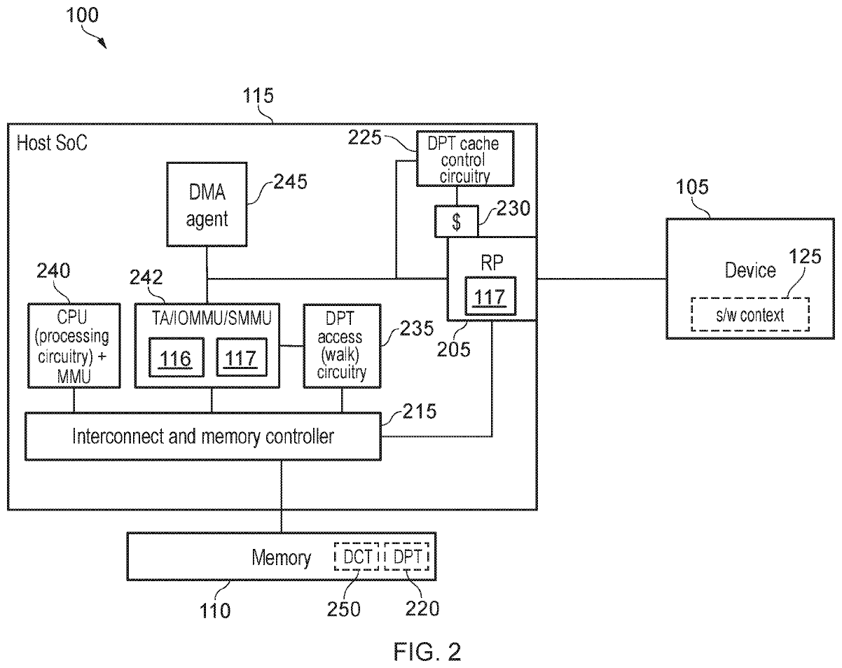

FIG. 2 illustrates an example of a system-on-chip (SoC) and an off-chip device sharing access to memory;

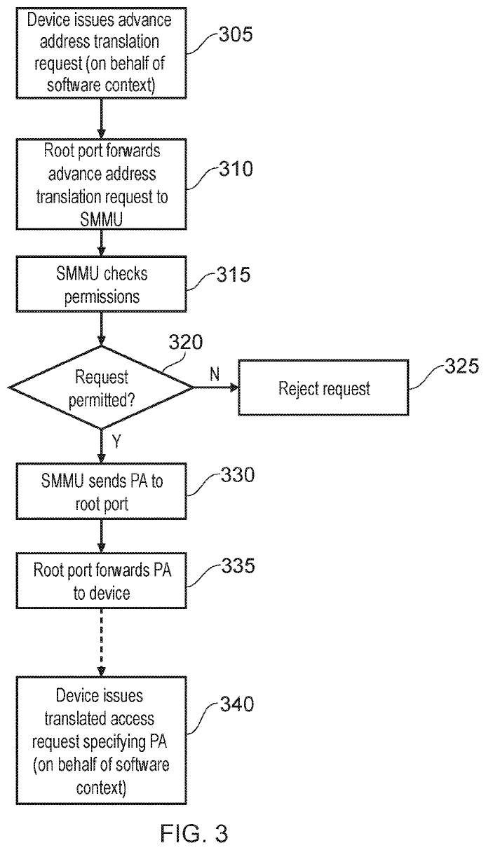

FIG. 3 illustrates a method of handling an advance address translation request;

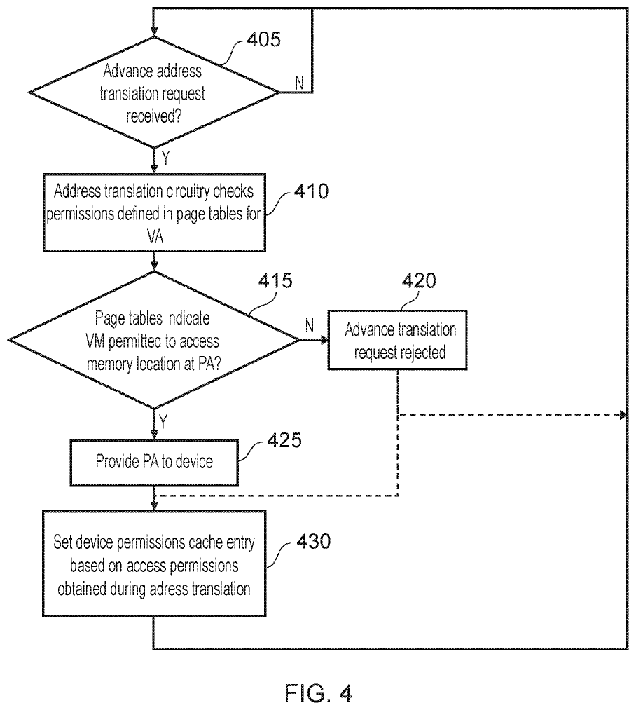

FIG. 4 illustrates another method of handling an advance address translation request;

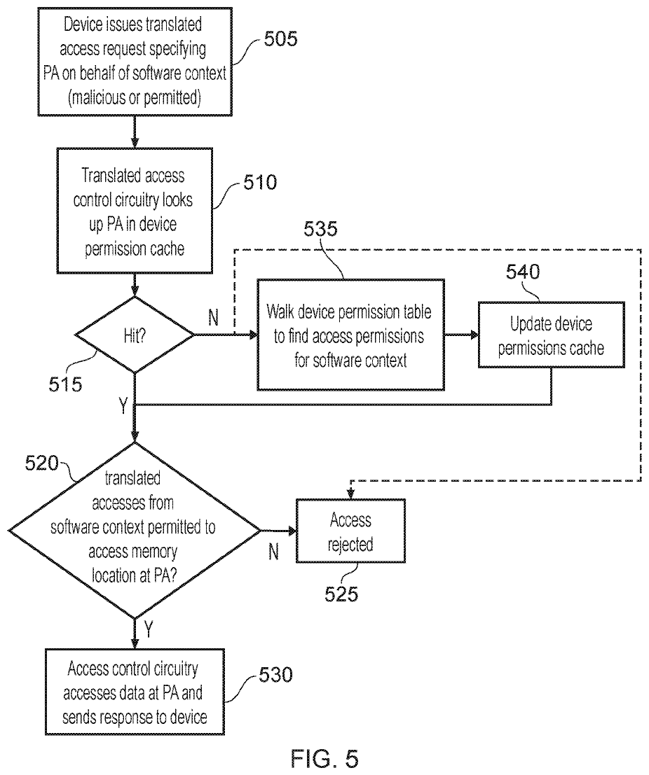

FIG. 5 illustrates an example method of handling a translated access request;

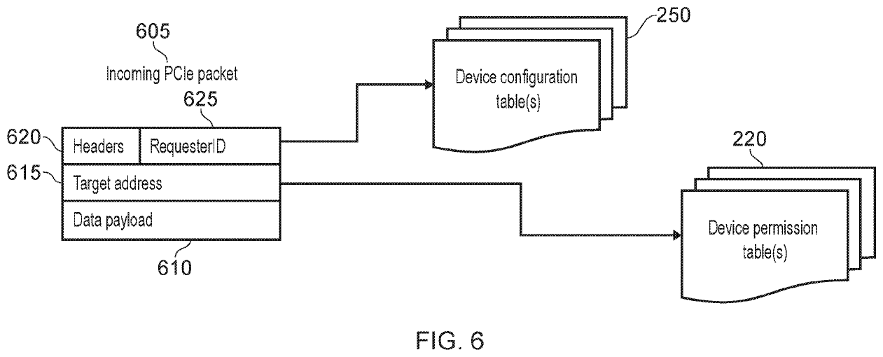

FIG. 6 illustrates an example of an incoming packet in a protocol such as peripheral component interconnect express (PCIe);

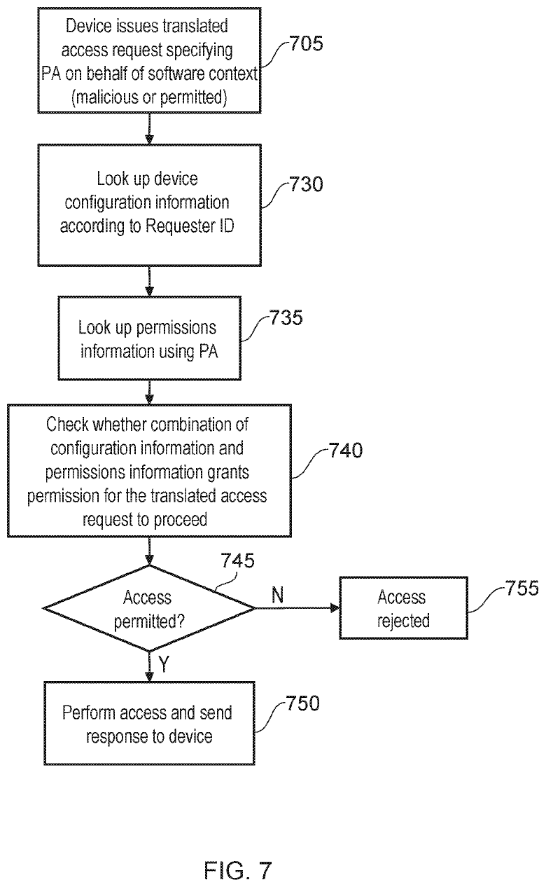

FIG. 7 illustrates another method of handling a translated access request;

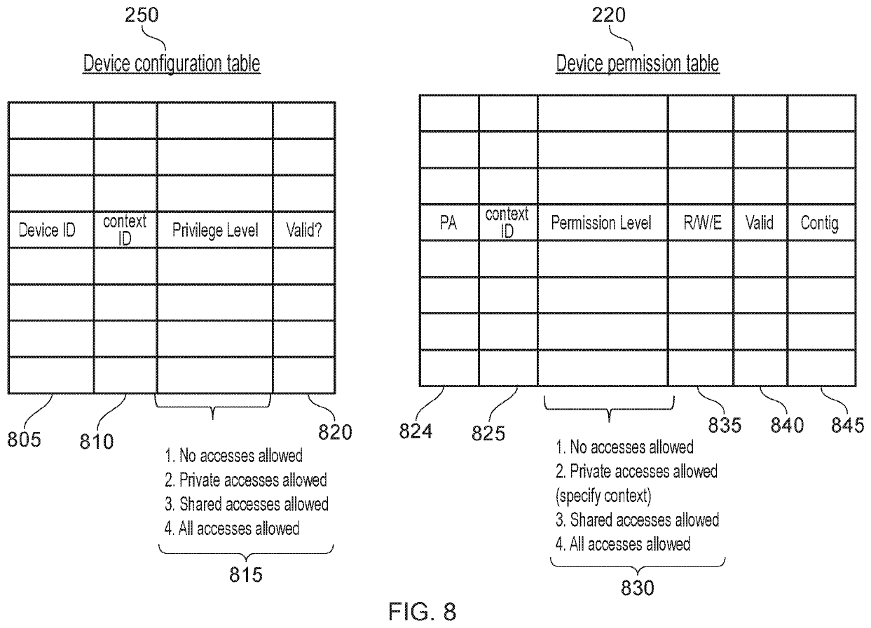

FIG. 8 illustrates a device configuration table and a device permission table;

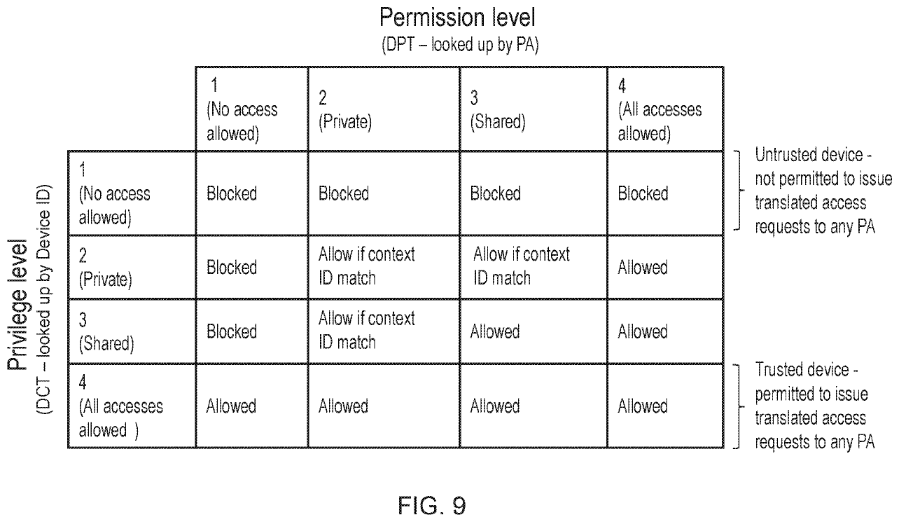

FIG. 9 illustrates an example set of permission levels and privilege levels, and the interaction between them;

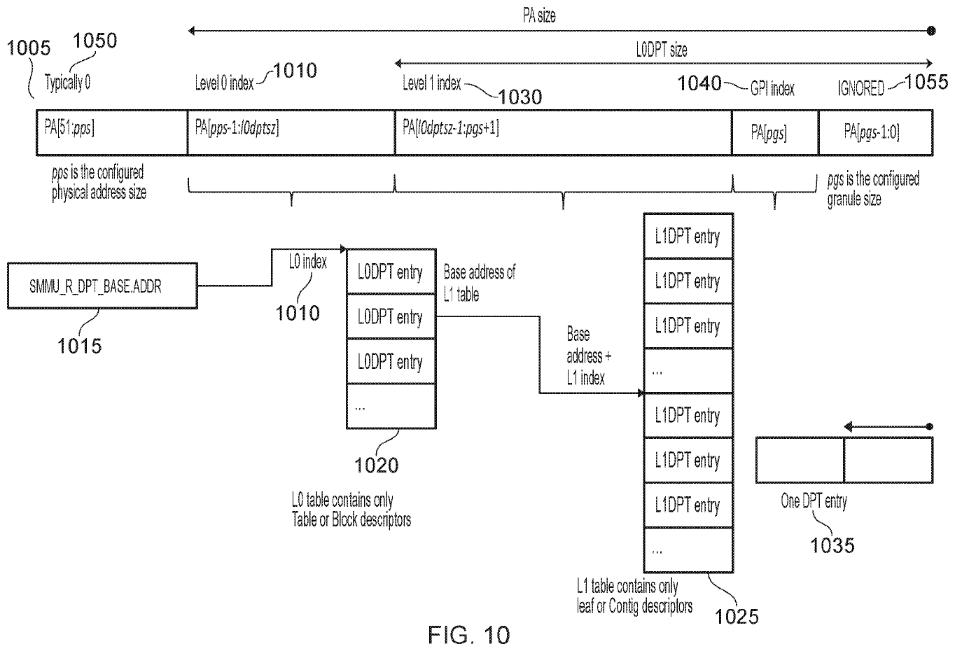

FIG. 10 illustrates an example of a physical address, and how it can be used to look up an entry in a device permission table; and

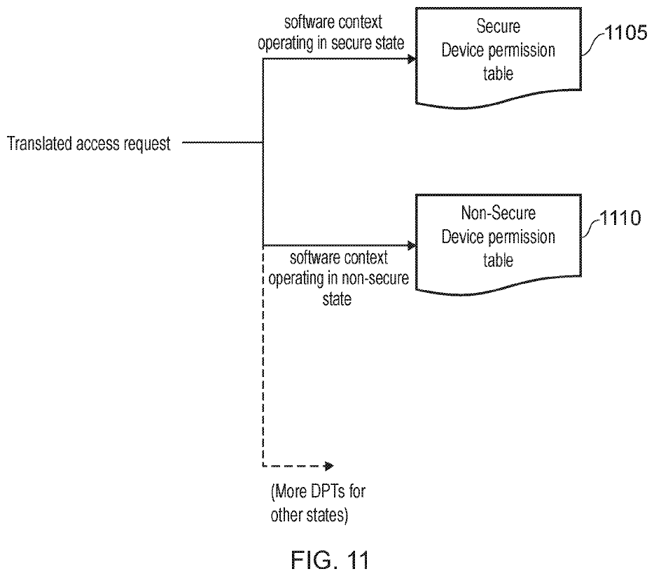

FIG. 11 illustrates an example of providing device permission tables for multiple execution states.

Before discussing example implementations with reference to the accompanying figures, the following description of example implementations and associated advantages is provided.

In accordance with one example configuration there is provided an apparatus comprising address translation circuitry configured to translate, in response to an advance address translation request issued by a requester device on behalf of a given software context and specifying a given virtual address, the given virtual address into a given physical address and to provide the given physical address to the requester device to be associated with a subsequent translated access request issued by the requester device. The apparatus also comprises translated access control circuitry responsive to a translated access request issued by the requester device on behalf of the given software context and specifying a target physical address, to:
look up, based on the target physical address, corresponding permissions information indicative of corresponding access permissions defined in a device permission table for a region of physical address space encompassing the target physical address, wherein the corresponding access permissions provide information for checking whether translated access requests from a plurality of software contexts are prohibited;
determine, based on the corresponding permissions information, whether the given software context is prohibited from accessing a target memory location corresponding to the target physical address in response to translated access requests; and
when it is determined that the given software context is prohibited from accessing the target memory location in response to translated access requests, trigger an error response.

In a data processing system, locations in memory can be identified using a physical address in a physical address space. Hence, a device could access data at a given location in memory by issuing an access request specifying the physical address corresponding to the given memory location. Devices can also issue access requests on behalf of software contexts (e.g. virtual machines, applications or a hypervisor) executing on the data processing system (e.g. the device may be a virtualised hardware accelerator or I/O device which is shared for use by a number of software contexts). However, some devices (or some software contexts) may not be trusted to only issue access requests to memory regions which they are permitted to access—for example, a malicious actor could cause a device to issue an access request to protected memory, or indeed such an access could be made in error (e.g. if the wrong physical address is specified for an access request). Hence, there is a potential security risk when a device is permitted to issue access requests specifying physical addresses.

To address this issue, one approach can be to prevent devices in a data processing system from sending access requests specifying physical addresses, and the device may instead issue access requests specifying virtual addresses from a virtual address space. These virtual addresses can then be translated, by address translation circuitry, into physical addresses. In some examples there may even be two stages of address translation-a first stage to translate the virtual address (VA) from a VA space into an intermediate address (which in a virtual machine or operating system's perception is in a physical address (PA) space, but which is really in an “Intermediate PA space” or “Guest PA space”), and the address in this address space may be referred to as an intermediate physical address (IPA)), and a second stage to translate the intermediate address into a PA in the system's PA space. However, it should be noted that two-stage translation is optional and that the present technique can be used whether or not a one-stage or two-stage address translation process is used.

Virtual addressing allows the address mappings defining the translation between the virtual addresses to physical addresses to be set so that certain physical addresses (not mapped to any virtual address for a given software context) cannot be accessed by requests made on behalf of that software context. Also, the address translation circuitry can perform checks at the time of translating the virtual address (e.g. access permission checks) to determine whether the requesting device is permitted to access a specified memory region. Hence, by preventing devices from directly accessing memory (e.g. by issuing a memory access request specifying a physical address), the security of the data processing system can be improved.

However, the process of translating a physical address to a virtual address and the checking of access permissions can be time consuming—for example, it may require a page table walk of page tables in memory to be performed. Even if a page table walk is not required (e.g. when a request can be translated using mapping information cached in a translation lookaside buffer), the address translation circuitry may be shared between multiple sources of memory access requests (e.g. between multiple devices) and so competition for translation bandwidth can delay servicing of address translations for a given access request.

Therefore, to reduce the latency of access requests, some devices may be permitted to issue advance address translation requests, which specify a virtual address to be translated but do not actually require an access to memory at that time. The address translation circuitry translates the virtual address into a physical address, checks any access permissions (if defined—it is not essential to define such access permissions), and then (if the device is permitted to access the memory location corresponding to the translated physical address) returns the physical address to the device. The device can then, at a later time (a time when a memory access to the location associated with the translated physical address is actually needed), issue a translated access request specifying the translated physical address. In this way, the latency associated with access requests issued by the device can be reduced. The reduction in latency may be even greater if the device needs to issue several access requests to the same location in memory (e.g. the translated physical address can be cached at the device to allow reuse for later access requests).

However, the inventors of the present technique realised that permitting the device to issue access requests specifying physical addresses still carries the risk that the device may issue a translated access request specifying a physical address of a memory location that it does not have permission to access. For example, the device may issue an access request specifying a physical address which was not received in response to an advance address translation request—for example, this could be as a result of a malicious actor or an error in operation.

Hence, it would be advantageous to be able to improve the security of the data processing system, while still providing the benefits of advance address translation (e.g. reduced latency associated with access requests).

To address this problem, the present technique provides translated access control circuitry (which could be an enhanced version of existing access control circuitry—e.g. for receiving translated physical addresses from the address translation circuitry and performing accesses in response to access requests specifying virtual addresses—or it could be dedicated circuitry for handling translated access requests), which responds to translated access requests by looking up permissions information corresponding to the target physical address specified by the request. The permissions information is defined in a device permission table (DPT), and indicates a set of access permissions associated with a region of physical address space (e.g. system PA space, in cases where two-stage address translation is implemented) encompassing the target physical address. For example, the permissions information could be the access permissions themselves, and in one example the translated access control circuitry looks up the access permissions directly in the table. The table can be a memory-based table, and so such a direct lookup in the table may be an access to the memory system (the same memory system to which access is controlled using the DPT) to access an entry of the DPT. However, in other examples, the lookup of the permissions information may be performed in some other structure (e.g. a cache), and the permissions information need not be in the same format as the access permissions in the DPT. Based on the permissions information, the translated access control circuitry can then determine whether the software context on behalf of which the access request was issued is prohibited from (e.g. not allowed) accessing a target memory location corresponding to the target physical address by issuing translated access requests. If the translated access control circuitry determines that the software context is not permitted to access the identified target memory location using translated access requests, an error response is triggered—for example, this may involve the translated access request being rejected, and/or it may involve a different response, such as updating an error log to record that a prohibited access request was made (but not necessarily preventing the access request itself from proceeding—the error log could then be checked before making later accesses to the affected physical address to check whether it is safe to rely on the contents of data stored at that physical address). In this way, the security of the system can be improved, while still supporting advance address translation.

Note that if the given software context is not permitted to access the identified target memory location using translated access requests, this does not necessarily mean that the given software context is also not permitted to access the identified target memory location using a non-translated access request which specifies a virtual address. It may be that the identified target memory location is actually accessible to the software context, provided that the memory access request to that location specifies a virtual address, so that the security provided by the address translation lookup by the address translation circuitry can be enforced. The reason for denying access to the target physical address could simply be that the device is not trusted to specify physical addresses directly, rather than a problem accessing the target physical address per se. Hence, the DPT may be a table used to control whether translated access requests (based on a physical address, which should already have been translated in response to an earlier advance address translation request) are permitted for the target physical address.

If the translated access control circuitry determines, based on the permissions information, that the given software context is not prohibited from accessing the target memory location in response to translated access requests, the request may be allowed to be serviced in memory, or it may be subject to further checks. Hence, while a failure to satisfy the requirements of the DPT may cause the request to be rejected (and/or may trigger some other error response), it is not essential that a request which satisfies the requirements of the DPT is accepted, as there could be other reasons for rejecting the request depending on what other checks are implemented for a given system (e.g. checks for reasons unrelated to the handling of advance address translation requests/translated access requests).

As explained above, access requests (including translated access requests) may be issued on behalf of software contexts. A software context could be a virtual machine, for example, which may be a virtual emulation of a computer system, which may share the physical hardware platform with other virtual machines. Other examples of software contexts are applications or a hypervisor. A device, such as an I/O device or hardware accelerator, may be configured to provide functions on behalf of a particular software context. It should be noted that there need not necessarily be a 1:1 correlation between software contexts and devices (e.g. a single software context may be associated with more than one device, or multiple software contexts may share a single device).

In the present technique, the access permissions defined in the DPT provide information that can be used to check whether translated access requests from a plurality of software contexts are permitted. For example, the access permissions may be shared between multiple software contexts, allowing a single DPT to define access permissions for multiple software contexts. This can help to reduce the overall memory footprint needed for table data compared to an alternative approach which defines an entirely separate table structure for each software context. Moreover, by enabling the use of a single DPT for multiple software contexts, this provides a DPT whose size is statically determinable (e.g. it is not necessary to allocate memory for an entirely new table each time a new software context begins executing). This can improve performance. Also, providing a single DPT structure shared between multiple software contexts can improve cacheability in implementations which cache information from the DPT structure, because it means that a single cache entry can be used to verify requests for multiple software contexts, rather than requiring separate cache entries for the respective contexts.

In some examples, the translated access control circuitry is configured to support at least one encoding of an entry of the device permissions table that identifies at least one access permission associated with an identified software context specified from among a plurality of software contexts by the entry of the device permissions table.

It can, in some situations, be desirable to define different access permissions for different software contexts—e.g. some software contexts may be prohibited from accessing a given memory region using translated access requests, while other software contexts are permitted access to that region using translated access requests. Hence, the translated access control circuitry according to the present technique also supports an encoding of the device permission table which enables an identified software context to be associated with a set of device permissions for a given physical address. This allows the permissions for a given physical address to be defined in dependence on the software context issuing a request, which can be useful as it allows a richer set of permissions to be defined. For example, this could allow some pages in memory to be accessible via translated access requests only to a particular software context, or shared between a particular software context and one or more other processes (when accessed using translated access requests). Hence, identifying a software context in association with a set of permissions information can further improve the security of the system and improve usability.

In some examples, the translated access control circuitry is configured to support the device permission table comprising a plurality of entries indexed by physical address, wherein each of the plurality of entries identifies an access permission for an associated region of physical address space.

Hence, unlike the page tables looked up by the address translation circuitry, the device permission table is, in this example, indexed by physical address, as opposed to being indexed by virtual address (or by an intermediate address provided by stage 1 of a two-stage address translation).

In some examples, the access permission comprises a device permission level selected from a plurality of device permission levels, and the at least one permission level comprises at least one of:
a private permission level identifying a given software context of the plurality of software contexts and indicating that translated access requests associated with processes other than the given software context are prohibited from accessing the associated region of physical address space; and
a shared permission level identifying a given software context of the plurality of software contexts and indicating that translated access requests associated with processes other than the given software context and a supervisor process operating at a higher privilege level than plurality of software contexts are prohibited from accessing the associated region of physical address space.

In this way, some pages in memory can be made (for the purpose of access via a translated access request) private to a given software context, offering greater protection for processes executed by the given software context, or can be shared by the given software context with a supervisor process. It will be appreciated that other permission levels may also be defined, in addition to the private and shared permission levels defined above. Hence, the device permission table may support a richer set of permissions than merely defining that access using translated access requests is either allowed or prohibited to a given address. As mentioned above, whether a given address is specified with the private or shared permission level for the purpose of handling translated access requests can be set separately from whether the given software context would be allowed to access the address using a non-translated access request specifying a virtual address—the permissions for non-translated access requests may be more or less permissive than the permissions for translated access requests.

In some examples, the translated access control circuitry is configured to look up, based on a device identifier specified in the translated access request, corresponding device configuration information indicative of the given software context associated with the device identifier, and when the corresponding permissions information specifies said at least one access permission associated with the identified software context, the translated access control circuitry is configured to determine whether the given software context is prohibited from accessing the target memory location in response to translated access requests based on a comparison of the given software context and the identified software context.

In this way, the association between a device and a software context can be variably configured using the device configuration information. By abstracting the relationship between a device and software context identifier using the device configuration table, and defining permissions in the device permission table which can be encoded to define software context specific permissions, this avoids the need to redefine detailed address-specific permissions in a device-specific table each time there is a change of software context on the device-instead it is sufficient to change the software context identifier associated with the device, with the device permissions table being able to remain the same. If a software context swaps use of devices, the permissions of that software context in the device permission table can easily become associated with a new device simply by updating the associated software context identifier indicated for the new device in the device configuration table.

In some examples, the translated access control circuitry is configured to support the device configuration table comprising a plurality of entries indexed by device identifier, wherein each of the plurality of entries identifies device configuration information for an associated device. Hence, unlike the device permission table which is indexed by physical address, the device configuration table is, in this example, indexed by device identifier.

In some examples, the device configuration information in each of the plurality of entries comprises privilege information indicating whether the associated device is prohibited from issuing translated access requests, the privilege information comprises a privilege level selected from a plurality of privilege levels, and the plurality of privilege levels include at least one privilege level indicating that the associated device is permitted to issue translated access requests even when the device permission table indicates that access to a subset of physical address space in response to translated access requests is prohibited for the at least one software context associated with the device identifier.

Hence, in at least some cases, the device configuration table can also be used to define a second set of permissions on a device by device basis, which can be orthogonal to the permissions defined on an address region by address region basis in the device permission table. This can allow a richer set of permissions to be expressed which can be useful for software. In some examples, the permissions indicated by the device configuration information in the device configuration table may supersede (take priority over) the permissions indicated by the permissions information in the device permissions table, allowing certain devices to be designated as (for example) trusted devices with more lenient access permissions that are indicated in the device permission table, or untrusted devices with stricter access permissions than those indicated in the device permission table. Other encodings of the device configuration table may indicate that the permissions indicated in the device permission table (for a particular memory region) should be followed.

In some examples, the apparatus comprises a device permission cache configured to store permissions information corresponding to a subset of access permissions defined in the device permission table, wherein the translated access control circuitry is responsive to the translated access request to look up, based on the target physical address of the translated access request, the corresponding permissions information in the device permission cache.

It may be significantly less time-consuming to perform a lookup in a cache—which can be implemented as a hardware structure associated with the translated access control circuitry and only stores a subset of the permissions information, meaning that there are fewer entries to consider—than it is to look up the device permission table in memory. Hence, providing a device permission cache storing permissions information for a subset of the access permissions allows the latency associated with access requests issued by devices to be reduced, which can lead to an increase in performance. It should be appreciated that the device permission cache may also cache other information, such as information from a security table indicating further access permissions dependent on security state.

In some examples, the translated access control circuitry is responsive to the advance address translation request to determine the corresponding permissions information for the region of physical address space encompassing the target physical address, and to store the corresponding permissions information to the device permission cache.

In some examples, the address translation circuitry is configured to look up, in response to the advance address translation request, a set of translation table permissions defined in an address translation table entry corresponding to the given virtual address and the given software context; and the translated access control circuitry is configured to determine the corresponding permissions information in dependence on the translation table permissions, and to store the corresponding permissions information to the device permission cache.

For example, the address translation table could be page tables in memory, defining virtual-to-physical address translations and associated access permissions, and the look up could be of these tables in memory, or a cache (e.g. a translation lookaside buffer, TLB) storing a subset of the translations defined in the page tables. The page tables may already specify some access permission information (e.g. whether read access, write access or instruction fetches are permitted to the corresponding page) and this information could be used to set the cached permissions information in the device permission cache. Since the address translation circuitry will already have looked up an address translation defined in the translation tables (to translate the given virtual address into the given physical address), using the access permissions defined in the translation table can avoid the need to look up the access permissions defined in the DPT, which may require an additional access to memory. This provides a further improvement in performance.

In some examples, the translated access control circuitry is responsive to determining, based on the translation table permissions, that at least one of the corresponding access permissions for the given physical address is unknown from the translation table permissions, to set, as the corresponding permissions information to be stored to the device permission cache, a default access permission.

In some cases—for example, where the access permissions identify device permission levels (e.g. the private or shared permissions) as discussed above—at least one of the access permissions for a given physical address may be unknown from the translation table permissions. For example, the translation table permissions may indicate access permissions for the given software context, but not for other software contexts. In such cases, the translated access control circuitry may be arranged, when pre-populating the cache in response to the advance address translation request, to set the corresponding permissions information in the DPT cache to a default access permission. For example, the default access permission could be the most restrictive access permission that still allows the given software context to access data stored at a memory location corresponding to the target physical address (e.g. the default could, in some examples, be to the “private” permission level discussed above). This allows for an improvement in latency for at least some translated access requests to the region encompassing the target physical address (e.g. those sent on behalf of the given software context), without compromising the security of the system (e.g. by making a pessimistic prediction).

In an alternative implementation, the translated access control circuitry may be configured to look up the device permission cache in response to the advance address translation request, and in response to detecting a miss in the DPT cache device permission table access circuitry may be configured to look up the given access permissions in the device permission table. This approach may incur higher latency than the approach of using access permissions defined in a translation table to pre-populate the cache (since it may require an additional access to memory), but nonetheless can improve latency associated with translated access requests. In particular, by pre-emptively looking up the device permission cache in response to the advance address translation request (even though the permissions in the advance address translation request will not be needed until the subsequent translated access request is received), any misses in the device permission cache can be detected early and the device permission cache linefill operation to store the required permissions in the device permission cache can be initiated early, to reduce the chance of misses when the translated access request is received.

In some examples, where the DPT cache is pre-populated in response to the advance address translation request, the device permission table access circuitry is configured to perform a further lookup of the device permission table in response to detection, during the lookup of the device permission cache performed in response to the translated access request, of an absence of the corresponding permissions information in the device permission cache. In these examples, the further lookup is based on the target physical address specified by the translated access request, and the further lookup comprises identifying the corresponding access permissions in the device permission table, and the device permission table access circuitry is configured to store the corresponding permissions information identified during the further lookup to the device permission cache.

Hence, in one implementation, the permissions information for a particular translated access request can be brought into the device permission cache after a miss detected at the time of performing the translated access request. This reduces the latency for subsequent translated accesses to the same region of physical address space, hence improving performance.

In other examples, the translated access control circuitry is configured to reject the translated access request in response to detection of an absence of the corresponding permissions information in the device permissions cache in the lookup of the device permissions cache performed in response to the translated access request. Further, in some examples this behaviour might be enabled or disabled on a per-device basis (e.g. indicating for a given device that “this device should never directly access physical address space”).

Hence, in an alternative implementation, the translated access request is simply rejected if the lookup of the device permission cache (performed at the time of the translated access request) results in a miss. This approach is counter-intuitive, since one might assume that this would lead to an increase in latency overall, due to the fact that any subsequent translated accesses to the same region of physical address space will also miss. However, the inventors realised that the lookup of the device permission cache should only miss for a small proportion of permitted translated access requests, since for translated access requests validly based on a physical address returned by an earlier advance address translation request, the corresponding permissions information should have been stored in the cache when the advance address translation request was serviced as described above. In addition, the inventors realised that the time taken to walk the device permission table is not likely to be significantly more than the time taken to, for example, re-issue the translated access request as a non-translated access request specifying a virtual address and perform the address translation for the virtual address using the address translation circuitry. Hence, in practice, the effect on the latency associated with permitted translated access requests will be minimal and it can be more efficient to simply reject translated access requests which miss in the device permission cache (in practice, many such translated access requests which miss in the device permission cache may in any case be prohibited accesses).

In some examples, the apparatus comprises device permission table walk circuitry configured to look up a multi-level table representing the device permission table, wherein each level of the multi-level table comprises entries associated with successively smaller regions of the physical address space, a final level of the multi-level page table defines the access permissions, and each level other than the final level defines pointers to a plurality of tables in the next level, the pointers being selectable based on a portion of a physical address.

By supporting a multi-level device permission table, the present technique avoids the need to reserve a contiguous range of address space of sufficient size to store the entire table covering the whole address range.

In some examples, an upper limit of a number of levels of the multi-level table supported by the device permission table walk circuitry is less than an upper limit of the number of levels of page tables supported by page table walk circuitry.

Hence, the device permission table may—even when implemented as a multi-level table—be flatter (e.g. have fewer levels) than a multi-level page table. This means that the access permissions defined in the table can be looked up more quickly than any access permissions which may be defined in the page tables, which leads to a reduction in latency and, hence, an improvement in performance. In practice, the granularity with which permissions are to be specified for the device permission table may be less fine-grained than the granularity used for address translation tables (e.g. because address mappings may need finer granularity than the device permissions), so providing a larger number of page table levels than device permission table levels can offer an improved balance between efficiency and functionality.

In some examples, the device permission table walk circuitry is configured to support at least one encoding of an entry of at least one level other than the final level indicating an access permission that applies to an entire block of physical address space covered by that entry at said at least one level other than the final level.

In this way, if the access permissions for all of a given block of physical addresses covered by a higher level table entry are the same, the access permission can be defined in a single entry of a higher layer table corresponding to the entire block of addresses. This means that there is no need to incur the latency associated with performing the table walk all the way to final level.

In some examples, the apparatus comprises a device permission cache configured to store permissions information corresponding to a subset of access permissions defined in the device permission table, and the translated access control circuitry is configured to support at least one encoding of an entry of the device permissions table indicating that access permissions for each of a plurality of regions of physical address space are identical and can be represented by a single entry in the device permission cache corresponding to a predetermined one of the plurality of regions.

For example, at least some entries in the DPT may hold a contiguous indicator (e.g. this could be a single bit, or a multi-bit indicator if multiple sizes of contiguous region are supported) indicating that the access permissions defined in that entry also apply to at least one other entry in the table (e.g. this could be an adjacent entry in the table). This may mean that a single entry in the device permissions cache can be used to indicate the access permissions for the regions of physical address space covered by multiple entries in the DPT (e.g. if the multiple entries are for contiguous regions in memory, this may mean that an entry of the device permissions cache can indicate permissions information for a larger region of memory). This improves the cacheability of the permissions information—and hence leads to a further reduction in latency—since it allows permissions information for a larger proportion of the address space to be stored in the device permissions cache simultaneously, without increasing the size of the cache.

In some examples, the translated access request is associated with a security state selected from amongst a plurality of possible security states, and the lookup of the corresponding permissions information is based on the security state and the target physical address.

For example, a software context may operate in one of a secure state (which could alternatively be referred to as a “trusted” or “confidential” state) or a less secure state (sometimes referred to as a “non-secure” state), or there may be more than two possible states defined, and different regions of the physical address space may be assigned for access in particular security states. For example, software contexts operating in one security state may be permitted to access more or different regions of the physical address space than software contexts operating in another security state (e.g. a software context operating in the less secure state may be prohibited from accessing certain regions of the physical address space which are associated with the secure state). Hence, it can be useful to further define access permissions on the basis of the security state within which a software context is operating, and to lookup the permissions information on the basis of a security state associated with a translated access request. This can provide an extra layer of security.

In some examples, the translated access control circuitry is configured to support a plurality of device permission tables, each corresponding to a different security state.

One way to specify access permissions that are dependent on the security state as well as on the physical address is to support a separate table for each security state. This approach may simplify lookups of the permissions information, since the DPT for each security state may not need to cover the entire physical address space (e.g. if a given security state is always prohibited from accessing a certain region of the physical address space, it may not be necessary to define access permissions for this region in the DPT for the given security state.

In some examples, the translated access control circuitry is configured to support, as the device permission table, a table shared between a plurality of devices to define access permissions for translated accesses issued by the plurality of devices.

For example, a single DPT may be used to define access permissions for multiple devices. This reduces the memory footprint of the DPT.

In some examples, the apparatus comprises a device permission cache configured to store permissions information corresponding to a subset of access permissions defined in the device permission table, processing circuitry configured to execute software, and device permission cache control circuitry configured to invalidate entries in the device permissions cache in response to a device permission cache maintenance command triggered by the software executing on the processing circuitry and having a different encoding to a translation look-aside buffer invalidation command for triggering invalidation of page table information from a translation look-aside buffer.

For example, a dedicated command may be defined for invalidating entries in the device permissions cache, which is different from any invalidation command used to invalidate entries of a translation look-aside buffer (TLB). Such device permission cache invalidate commands can be used to invalidate entries of the device permission cache that are out of date, e.g. because the corresponding access permissions in the DPT have been updated. This can help to improve security. The device permission cache invalidate command could, in some examples, specify at least one filter condition used to select which device permission cache entries to invalidate. For example, the device permission cache invalidate command could specify an address range or specific address for which device permission cache entries are to be invalidated (this could be specified using a virtual address and so require translation, but in other examples it may be simpler to support only a physically addressed device permission cache invalidate command). The filter condition could also be based on a software context identifier (e.g. a virtual machine identifier, VMID). In other examples, the device permission cache invalidate command could simply be a global command which triggers all entries of the device permission cache to be invalidated.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may be define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular embodiments will now be described with reference to the figures.

FIG. 1 shows an example of a data processing system 100 comprising multiple devices 105 with access to a shared memory 110. Each device 105 is configured to perform operations under the control of one or more software contexts 125—for example, each device may be associated with a single software context (e.g. device 105c and software context 125c), or with more than one software context (e.g. device 105a and software contexts 125a and 125b.) Moreover, a single software context 125 can also be associated with more than one device 105 (e.g. software context 125d is associated with two devices 105d, 105e). Each software context could, for example, be a virtual machine (VM), a hypervisor or an application. While FIG. 1 shows the devices 105 as off-chip devices separate from the SoC 115, the techniques shown below could also be used for on-chip devices on the same integrated circuit as other components of the SoC 115.

The data processing system 100 also includes a system-on-chip (SoC) 115 coupled to the memory 110, and coupled to each of the devices 105 via an interconnect 120. The SoC 115 comprises address translation circuitry 116, which is configured to translate virtual addresses (VAs) into physical addresses (PAs) which directly identify locations in the memory 110. For example, the devices 105 may, under control of a software context 125, issue access requests to access data in the memory 110, and the access requests may specify virtual addresses from a virtual address space, that need to be translated into physical addresses in order to perform the access in memory. Some of the devices are also configured to issue advance address translation requests specifying a virtual address to be translated, by the address translation circuitry, into a physical address that is then returned to the device (without actually requesting memory access to the memory system location associated with that physical address at the time of servicing the advance address translation request). The device can then issue translated access requests specifying the translated physical address.

Hence, the SoC 115 also comprises access control circuitry 117, which controls access to memory 110. In particular, the access control circuitry 117 receives physical addresses from the address translation circuitry 116 (e.g. following translation from a VA specified in an access request) and from the devices 105 (e.g. with a translated access request), and performs accesses to data stored at corresponding locations in memory 110. Hence, the access control circuitry 117 acts as both access control circuitry for controlling access to memory in response to normal (e.g. not translated) access requests, and also translated access control circuitry for controlling access to memory in response to translated access requests. However, it should be noted that in that some implementations, separate access control circuitry and translated access control circuitry could be provided.

As noted above, the address translation circuitry 116 supports advance address translation requests. Providing support for advance address translation requests can be advantageous, because it allows subsequent translated access requests issued by the devices 105 to specify a physical address. This means that translated access requests can be serviced more quickly (e.g. with reduced latency) than normal access requests (e.g. access requests specifying a virtual address), since the process of translating the virtual address into a physical address has already been performed. In some examples, a given process executing on one of the devices 105 may need to access a particular memory location multiple times. Servicing an advance address translation request to provide the physical address corresponding to that particular memory address means that the latency associated with address translation need only be incurred once, while the device 105 can subsequently issue multiple translated access requests specifying the physical address. This can provide a further reduction in latency (and reduction in pressure for translation bandwidth at the address translation circuitry 116 compared to performing a new translation for each access to the same address). Nevertheless, even for an address only accessed once by the device 105, advance address translation can still be useful to remove the latency of address translation from the critical timing path at the time when the memory access is actually needed

Much of the latency associated with address translation is typically due to the need to check address mappings and access permissions for the access request or advance address translation request received by the address translation circuitry 116, which may encounter a delay while waiting for sufficient translation bandwidth when the address translation circuitry 116 is shared between multiple requesters and possibly a long delay in accessing memory 110 to obtain the relevant translation table entry providing the address mapping and access permissions, if the required entry is not already cached at the address translation circuitry 116.

For the access permissions checks, the address translation circuitry 116 may check whether the requesting device 105 (e.g. the device issuing the request) and/or the software context 125 operating on the device 105 is permitted to access the identified location in memory. Hence, for advance address translation requests, the physical address may be returned to the device on the condition that any required access permission checks have passed.

However, in reality, it may be possible for devices 105 to issue translated access requests specifying physical addresses which were not received from the address translation circuitry 116 in response to advance address translation requests. For example, a malicious actor may insert, in program code executed by one of the devices 105, a translated access request specifying a physical address which the device 105 is not permitted to access. In another example, the device 105 may specify a protected physical address in error. Either situation could lead to the device 105 accessing data in memory 110 that it is not permitted to access. This leads to a potential security risk, unless the address translation is performed again (with additional access permissions checking) at the access control circuitry 117 when the translated access request is received. However, one would expect that re-performing the address translation and access permissions checking when translated access requests are issued may negate the performance improvements otherwise associated with advance address translation; one might think that there is no point in issuing translated access requests if they will need to be subject to the same access permissions checking—and hence the same associated latency—as un-translated access requests (e.g. access request specifying virtual addresses).

However, the inventors of the present technique have proposed an alternative approach, which can improve the security a system employing advance address translation without significantly increasing the latency associated with access requests.

FIG. 2 shows a particular example of an SoC 115, in communication with a device 105, and connected to memory 110. While memory 110 is shown in the diagram as off-chip separate from the SoC 115, it will be appreciated that the memory 110 can also include on-chip memory on the same integrated circuit as the SoC 115. The SoC 115 in this example includes a root port 205, configured to forward messages received from the device 105 to components within the SoC 115, and to forward messages from within the SoC 115 to the device 105. The SoC 115 also includes a central processing unit (CPU) 240, which includes a memory management unit (MMU) for translating VAs into PAs for access requests issued by processing circuitry on the CPU. The SoC also includes a direct memory access (DMA) agent 245 (an example of an on-chip device), and a system memory management unit (SMMU) 242, which can also be referred to as an input/output MMU (IOMMU), or a translation agent (TA)), which receives requests from the DMA agent 245 and the root port 205, and translates VAs specified in the requests into PAs. The SMMU 242 comprises the address translation circuitry 116 described earlier, which performs the address translation and also checks various access permissions—e.g. these access permissions (as well as the address mappings for the translation) may be defined in page tables stored in memory 110. The address translation circuitry 116 may have a translation lookaside buffer (TLB) for caching page table entries for faster access than in the memory 110.

The access control circuitry 117 mentioned earlier may be provided within the SMMU 242 for generating access requests to be sent to the memory system based on the translations performed by address translation circuitry 116. The access control circuitry 117 can also be implemented as distributed circuit logic, including not only a portion in the SMMU 242 but also a portion of (translated) access control circuitry 117 in the root port 205. It can be useful to provide part of the translated access control circuitry 117 in the root port 205 so that translated access requests (which do not require address translation as they already specify a physical address) can be issued to memory without passing via the SMMU 242, to conserve bandwidth at the SMMU 242 for requests which do require translation. On the other hand, the parts of access control circuitry 117 used to service non-translated requests translated by the address translation circuitry 116 can be provided at the SMMU 242 itself.

An interconnect 215 is also provided, which includes a memory controller for controlling access to memory in response to access requests specifying PAs. For example, this can include access requests forwarded to the interconnect 215 by the address translation circuitry 116 following translation of a VA to a PA, and/or translated access requests forwarded by the root port 205 from the device 105, as well as memory access requests made by the CPU 240 based on address translation by the CPU's MMU.

For a device memory access, if the permissions checks are all passed (e.g. if it is determined based on page table permissions that the device 105 and/or software context 125 is permitted to access the memory location), then the access request is passed on to the interconnect/memory controller 215, and the memory controller accesses the relevant location in memory 110, before providing a response to the root port 205 for forwarding to the device 105.

The SoC 115 also includes a device permission cache 230 which, in this particular example, is associated with the root port 205. However, in other examples, the cache 230 may be associated with multiple different root ports 205 (where more than one root port 205 is provided), or may instead be associated with the SMMU 242. The device permission cache is controlled by device permission cache control circuitry 225, which is responsive to translated access requests received by the root port 205 to look up the device permission cache 230 based on the translated physical address specified in the request. If there is a hit in the device permission cache 230, the permissions information in the identified entry is checked, and the translated access request is either rejected or permitted based on a set of access permissions indicated by the permissions information. If the access permissions indicate that the translated access request is permitted, it is passed on to the memory controller 215 to be serviced. Accordingly, the security of translated access requests can be improved, by performing an additional lookup of the permissions information when a translated access request is received.

The permissions information stored in the device permission cache 225 is a subset of a set of access permissions defined in a device permission table (DPT) 220 in memory 110. Hence, if a lookup in the device permission cache (also referred to herein as a DPT cache) 230 misses, a lookup of the DPT can be performed to find the required access permissions. Unlike any access permissions which may be defined in the page tables referenced by the address translation circuitry 116, the access permissions defined in the DPT (and the corresponding permissions information in the DPT cache) are indexed by physical address, so that they can be looked up on the basis of a PA specified by a translated access request.

Providing a DPT cache 230 in addition to the DPT in memory helps to reduce the latency associated with translated access requests, since cache typically lookups consume significantly less time than lookups of structures in memory. This allows the extra security provided by checking these access permissions for translated access requests to be provided without significantly increasing the latency associated with translated access requests.

Moreover, in some implementations the DPT cache may be pre-populated with permissions information at the time of performing an advance address translation request. For example, access permissions defined in page tables in memory (which would have been looked up during the address translation) may be used to populate the cache. Alternatively a lookup of the permissions information may be performed in the DPT at the time of handling an advance address translation request. For example, this could involve performing a lookup in the DPT cache to see if the corresponding permissions information for the translated physical address are already defined in the cache, and performing a linefill if the permissions are not present. In either implementation, since the corresponding permissions information was stored in the cache when the advance address translation request was serviced, the lookup of the DPT cache 230 at the time of receiving a translated access request from the device 105 is less likely to miss, unless the physical address was not provided to the device 105 in a previous advance address translation request or the permissions for that address have already been evicted from the device permissions cache 230 due to capacity conflict by the time the translated access request is received (the size of the device permissions cache 230 can be chosen to make such capacity conflicts less likely). Hence, in either implementation, the permissions information for translated access requests is pre-loaded into the DPT cache 225 at the time of performing the advance address translation. This means that, provided the translated access request specifies a physical address obtained in response to an advance address translation request (which is only possible for permitted translated access requests), the lookup in the DPT cache 230 at the time of receiving the translated access request should usually hit, and hence the latency associated with checking the permissions information will be minimal for permitted translated access requests.

Moreover, in this example, device configuration information defined in a device configuration table (DCT) 250 is also looked up when a translated access request is received. The DCT identifies a correspondence between software contexts 125 and devices 105. The DCT 250 can also specify further permissions to be applied to translated access requests on a device-by-device basis (which may provide an additional layer of protection above the region-by-region permissions defined in the DPT 220 indexed using a physical address). The DPT 220 and DCT 250 will be described in more detail below.

Although not explicitly shown in FIG. 2, the device configuration information could also be looked up at the time of responding to an advance address translation request, and entries of the DCT 250 may be cached in the device permissions cache 230 or in a separate cache used for device configuration information from the DCT 250.

The format of information cached in the device permissions cache 230 need not be exactly the same as the corresponding information in the DCT 250 or DPT 220 on which that cached information is based. For example, information from the DCT 250 and DPT 220 could be combined in a combined format, or the information could be stored in a compressed form in the cache 230, or in an expanded form which also includes other information.

As noted above, when the address translation circuitry 116 receives a virtual address (either specified by an access request or an advance address translation request), it may check a set of access permissions defined in page tables in memory 110 (which also define translations between virtual addresses and physical addresses).

The information in the DCT 250 and DPT 220 may be controlled by software executing on the CPU 240. The access control permissions which govern which software is allowed to update entries in the DCT 250 or DPT 220 may be set in the page tables used by the MMU of the CPU 240, so that the page tables for a given software process define whether the addresses of the DCT 250 and DPT 220 are accessible to the given software process. The CPU 240 may support a device permission cache maintenance command which can be used by software to trigger invalidation of DPT (and DCT) information cached in the device permissions cache 230, which can be issued by software when the software changes any information specified in the DCT 250 or DPT 220. The device permission cache maintenance command could simply be a global cache invalidation command which triggers invalidation of all entries in the device permissions cache 230, or could be a finer-grained invalidation command which triggers invalidation of entries meeting certain filter criteria (e.g. cached DPT/DCT entries which correspond to a specified software context identifier, or cached DPT entries corresponding to a particular physical address or physical address range). The filter criteria can be specified by the device permission cache maintenance command. The device permission cache maintenance command could be an instruction supported in the instruction set architecture of the CPU 240, or could be a memory-mapped command triggered by the software by issuing a read or write memory access request specifying an address which is mapped for representing commands addressed to the SMMU 242 or to the DPT-handling components 235, 230, 225. The type of command could be represented by the particular address specified by the memory-mapped command, or for a write request by the write data provided as the payload of the memory transaction. Hence, there are a wide range of ways in which the CPU 240 could (in response to software) signal that entries of the device permissions cache 230 should be invalidated, but in general it can be useful to support such a mechanism so that out of date information can be invalidated when the DCT 250 or DPT 220 is updated in memory 110.

FIG. 3 shows an example of how an advance address translation request issued by a device 105 might be handled by address translation circuitry and other components of the SoC.

As shown in FIG. 3, an advance address translation request is issued 305 by a device on behalf of a software context operating on the device. The advance address translation request specifies a VA to be translated into a PA, and is received at the root port, which forwards 310 the advance address translation request to the address translation circuitry (e.g. an SMMU). The address translation circuitry then looks up the VA in a set of page tables in memory (or in a translation lookaside buffer (TLB)), and checks 315 the access permissions defined in the page tables for the virtual address. If it is determined 320, based on these access permissions, that the advance address translation request is not permitted (“N”), the request is rejected 325, and a translation of the VA to a PA is not provided to the device. On the other hand, if it is determined 320 that the advance address translation request is permitted (“Y”), the address translation circuitry translates the VA to a PA (the TLB or page table entry for the VA also specifies the corresponding PA), and sends 330 the PA back to the root port, to be forwarded 335 to the device. The PA can then be specified in a translated access request that is subsequently issued 340 by the device.

As noted above, the access permissions looked up by the address translation circuitry in this example are different to those defined in the DPT, particularly in that they are defined in page tables which are looked up based on a virtual address. The DPT defines a further set of permissions which defines whether a particular physical addressed region is allowed to be accessed by a particular software context using translated access requests specifying a physical address. The permissions in the DPT may be less or more permissive than permissions defined in the page tables—e.g. the DPT could deny access (using translated access requests) which would have been accessible using a non-translated access request if looked up using the page tables based on virtual address.

FIG. 4 shows another example of how an advance address translation request issued by a device 105 might be handled by address translation circuitry and other components of the SoC. The method shown in FIG. 4 may include all of the steps in FIG. 3, but also includes pre-populating the DPT cache based on access permissions defined in the page tables.

In the method shown in FIG. 4, when it is determined 405 that a device has issued an advance address translation request on behalf of a software context (“Y”), the address translation circuitry looks up the VA specified by the request in a TLB or page tables, and checks 410 the access permissions defined in the page tables for the VA. If the address translation circuitry determines 415 that the request is permitted (“Y”), the PA obtained by translating the VA is provided 425 to the device.

In this example, for an advance translation request which is successful (the PA is returned to the device) the translated access control circuitry 117 also sets 430 permissions information in the DPT cache for the physical address. For example, the permissions information may be set based on access permissions defined in the page tables, which will already have been looked up when performing the address translations. These permissions will typically be defined for a particular software context (e.g. separate page tables may be provided for different software contexts, since each software context may be associated with a different virtual address space). Hence, the access permissions defined in the page table for the translated VA will indicate whether the requesting software context is permitted to access that memory location (and may indicate specific types of requests that may be permitted, e.g. reads and/or writes), and not whether or not any other software contexts are also permitted access to that memory location. Hence, when the cache is pre-populated based on the page tables, it may be appropriate to set permissions relating to other software contests to a default permission level. In a particular example, if the page tables indicate that the requesting software context is granted read and write access to a memory region encompassing the PA, the permissions information in the corresponding DPT cache entry may be set to indicate that the memory region is “private” to that software context for read and write accesses (e.g. to indicate that read and write accesses from that software context are permitted, but read and write requests on behalf of other contexts are not prohibited).

In an alternative implementation, instead of setting the permissions information based on the access permissions defined in the page tables, the address translation circuitry may look up the permissions information in the DPT cache. If it is determined that there was a hit in the DPT cache then no further action is taken. On the other hand, if it is determined that there was not a hit (e.g. there was a miss) in the DPT cache, DPT access circuitry 235 accesses the required device access permissions in the DPT, and the DPT cache control circuitry 225 updates the DPT cache to allocate the obtained device access permissions to the DPT cache 230. This is another approach to warming up the DPT cache 230 ready for a subsequent translated access request which is likely to specify the same physical address. This particular approach allows the full set of access permissions defined in the DPT for the PA to be copied into the DPT cache, but can incur greater latency that the approach using the page table permissions, since it may require an extra access to memory to read the DPT.

Returning to step 415, if the check of the address translation circuitry determines 415 that the software context is not permitted to access the memory location identified by the PA (“N”), the request is rejected 420. At this point, as shown by the dotted lines, it is possible that the lookup 430 of the DPT cache is still performed; however, in some implementations this might be considered an unnecessary extra step, given that the corresponding PA was not allowed to be accessed by the device.

FIG. 5 shows a method of handing translated access requests. In the method of FIG. 5, a device issues 505 a translated access request specifying a PA. The translated access request is sent by the device on behalf of a software context, and while normally legitimate (it was translated earlier following an advance address translation request), it could be malicious (e.g. the device may specify a PA that the software context is not permitted to access). Translated access control circuitry 117 is then responsive to the translated access request to look up 510 the physical address in the device permission cache 230. If the translated access control circuitry 117 detects 515 a hit in the device permission cache for the physical address, it accesses the identified entry in the DPT cache and determines 520, based on the permissions information defined in the identified entry, whether translated access requests issued by the requesting software context are permitted to access the memory location corresponding to the specified physical address. If such accesses are not permitted (“N”), the access is rejected 525. On the other hand, if it is determined 520 that such accesses are permitted (“Y”), the access control circuitry 117 issues a memory request requesting access 530 to the data at the identified memory location and sends a response to the device.

Returning to step 515, if a hit is not detected in the DPT cache (“N”)—e.g. if a miss is detected—DPT walk circuitry may look up 535 the access permissions for the PA in the DPT table. The DPT cache is then updated 540 to store the required access permissions, and the method continues to step 520.

However, in an alternative implementation (as shown by a dashed line), the lookup 535 of the DPT and updating 540 of the DPT cache may be omitted, and the translated access control circuitry may instead simply reject 525 any translated access requests for which a hit is not detected in the DPT cache (in response to which, the device may issue a further access request specifying a VA instead of a PA). As explained above, due to the early cache linefill shown at steps 440, 445 of FIG. 4 for an advance address translation request, it can be relatively rare that the lookup of the DPT cache will miss if the translated access request is permitted, and hence in some cases the circuit logic required to support DPT table walks and cache linefills at the time of handling a translated access request may not be justified (particularly in the case where the translated access control circuitry 117 is distributed so that the portion of circuit logic at the root port 205 need not be provided with the ability to trigger DPT table walks, as this can be done in the portion that is at the SMMU 242 which invokes such DPT table walks at the time of handling the advance address translation request). Alternatively, the lookup 535 of the DPT and updating 540 of the DPT cache may be dependent on the configuration information defined in the DCT—for example, these step may be omitted if it is determined, from the configuration information, that the device is not permitted to issue translated access requests at all.

The device may communicate with the SoC 100 according to any protocol, but one example of a standard which can be used for communication by a device and, for example, an SoC is the peripheral component interconnect express (PCIe) standard.

FIG. 6 shows an example of a packet 605 carrying a translated access request, using the PCIe standard. In this example, the packet 605 includes a data payload 610 and a target address 615. The target address is a physical address, and the data payload holds, in the case of write requests, data to be written to the target address. The packet 605 also includes headers 620, which define the request (e.g. in this case, indicating that the packet 605 comprises a translated access request, and indicating whether it is a read request or a write request) and specify a requester identifier 625 (also referred to herein as a device identifier), which identifies the device which sent the request.

As shown in the figure, the requester identifier 625 is used to look up device configuration information defined in one or more device configuration tables 250 (the device configuration information may specify the software context identifier of the software context 125 associated with the device that issued the packet 605), and the target address 615 is used to look up permissions information defined in one or more device permission tables 220.

FIG. 7 is a flow diagram illustrating another example of responding to a translated access request, in which both the DPT and the device configuration table (DCT) are considered. In this example, when a translated access request is received 705, the translated access control circuitry 117 looks up 730 device configuration information (defined in the DCT) according to a requester identifier indicated by the request. The device configuration information specifies the software context identifier associated with the requester identifier (and may optionally also specifying device-specific permissions information as described below), and may be looked up in the DCT (in memory) or in a cache. The translated access control circuitry also looks up 735 permissions information (defined in the DPT) based on the physical address specified as the target address of the request—again, this may be looked up in the DPT in memory, or in the DPT cache. Based on the device configuration information in combination with the device permissions information, the translated access control circuitry checks 740 whether the translated access request is permitted to proceed. If the translated access control circuitry determines 745 that the access is permitted to proceed, the access is performed 750 and a response is returned to the requester. Otherwise, the access is rejected 755. If the access is rejected, this does not necessarily mean that the device cannot access the corresponding physical address at all, as the device can instead issue a non-translated access request specifying a virtual address, which can then be processed using the address translation circuitry 116 based on address mappings and access permissions defined in page tables.

It should be noted that the order of the steps shown in the flow diagram is purely illustrative, and in reality some of the steps could be performed in a different order to that shown—for example, steps 730 and 735 could be performed in either order, or in parallel with each other. Further, the information looked up in steps 730 and 735 could, in some example implementations, be defined in the same cache entry, in which case a single lookup of that entry will cover both steps.

FIG. 8 shows examples of a device configuration table (DCT) 250 and a device permission table (DPT) 220. In this example, the DCT 250 specifies, for each device (e.g. as identified by a device identifier 805) the associated software context identifier 810, indicative of a software contexts associated with the identified device. For example, the software context indicated in the DCT for a given device is the software context currently associated with the device. In addition, the DCT 250 specifies a privilege level (also referred to herein as device configuration information) 815, and each entry also includes a valid indicator 820, indicating whether the entry is valid.

The privilege level 715 indicates whether the identified device is permitted to issue translated access requests on behalf of the identified software context(s), and what types of access are or are not permitted. In other words, the device privilege level may indicate a level of trust associated with the device. In this particular example, four privilege levels are defined:
1. No accesses allowed. If a privilege level of 1 is specified, this indicates that the identified device is not permitted to issue translated access requests on behalf of any software context. A device with a privilege level of 1 may be considered to be an untrusted device.
2. Private accesses allowed. If a privilege level of 2 is specified, this indicates that the device is permitted to issue translated access requests, on behalf of the software context identified, to memory locations that are indicated in the DPT as accessible only to the identified software context—e.g. memory locations which are defined as private to the software context(s).
3. Shared accesses allowed. If a privilege level of 3 is specified, this indicates that the device Is permitted to issue translated access requests on behalf of the identified software context to memory regions that are private to the software context, or that are shared between the software context(s) and one or more other processes.
4. All accesses allowed. If a privilege level of 4 is specified, this indicates that any translated access request issued by the device on behalf of the identified software context is permitted (even to memory regions marked in the DPT as being not accessible, private or shared—in this case the DCT permission takes priority over the DPT permission). A device with a privilege level of 4 may be considered to be a trusted device, trusted not to specify incorrect physical addresses that were not previously returned by an earlier advance address translation request.

Hence, the DCT enables a range of different permission levels to be assigned to specific devices. Some devices may have undergone rigorous control during manufacture so as to establish a root of trust in the device, so may be allocated the more privileged permissions 3 or 4. Other devices may be cheaper and are not known to have undergone such rigorous manufacturing steps and could be more vulnerable to tampering or error, and may be assigned the stricter permission levels 1 or 2 to restrict the ability to use translated access requests specifying physical addresses directly.

Turning now to the DPT 220, this table specifies, for each physically addressed memory region 824, a software context identifier 825 of an associated software context, and a permission level 830, which defines a set of access permissions for the corresponding region. The table also defines read/write/execute indications 835, to identify whether the permissions information is applicable to read accesses, write accesses and/or execute accesses, and each entry also includes a valid indicator 840 indicating whether the entry is valid, and a contiguous value 845. Alternatively, the DPT entry may contain a permissions “index”: a small integer value that can be used to look up a separate configurable register or table of permissions configurations. The contiguous indicator 845 indicates, when it is set, that the permissions information defined in that entry is identical to permissions information defined in one or more other entries (and hence that these multiple entries could be represented in a single entry of the device permission cache).

The permission level 830 indicates the extent to which the corresponding memory region can be accessed using translated access requests. In particular, four permission levels are defined in this example:
1. No access allowed. If a permission level of 1 is recorded, this indicates that the identified memory region is not permitted to be accessed using any translated access requests. If the region has a permission level of 1, a software context identifier need not be specified (the software context ID field 825 can be ignored), since the access permission in this case is independent of the software context identifier.
2. Private accesses allowed (for a specified software context). If a permission level of 2 is recorded, along with an identified software context, this indicates that the memory region is private to the identified software context, and hence that translated access requests to the identified memory region from the identified software context are permitted, but other translated accesses from other software context s are not permitted.
3. Shared accesses allowed. If a permission level of 3 is recorded, this indicates that access to the indicated memory region is shared between the indicated software context and one or more other processes (e.g. the indicated software context and a supervising process that supervises the indicated software context), and hence that the software context and the one or more other processes are permitted to access that region using translated access requests. Optionally, a DPT entry could also have an additional software context ID field to specify additional software context IDs of other software contexts that are allowed to share access with the indicated software context to that memory region.
4. Access allowed. If a permission level of 4 is recorded, this indicates that translated accesses to the identified memory location are permitted to be issued by any process. Again, if the PA has a permission level of 4, a software context need not be specified, since the access permission in this case is independent of the software context ID.

Hence, the DCT defines device-level access permissions (e.g. each entry of the DCT corresponds to a particular device, but not to a specific range of addresses), while the DPT defines address-level permissions (e.g. each entry corresponds to a particular range of physical addresses).

In some cases, when a device issues a translated access request indicating a given PA, it may be possible for the privilege level defined in the DCT for that device to conflict with the permission level defined in the DPT for the indicated PA. Hence, in some cases, one of the privilege level and the permission level may supersede (take priority over) the other.

FIG. 9 illustrates how the privilege levels defined in the DCT 250 and the permission levels defined in the DPT 220 can, in one example, combine to indicate whether a translated access request is permitted. In this example, there are some instances where the privilege level takes precedence over the permission level—e.g. when a privilege level of 1 is defined, then the access is always blocked, and when a privilege level of 4 is defined, the access is always permitted. For example, a privilege level of 1 may indicate that a device is untrusted, and hence that all translated access requests issued by that device should be rejected, regardless of the PA specified in the request. Similarly, a privilege level of 4 may indicate that a device is trusted, and that translated access requests issued by that device should be permitted, regardless of the PA specified in the request. In this way, when a device is considered trusted or untrusted, this can be indicated by updating a single entry in the DCT, rather than needing to update a large number of entries in the DPT. This may also avoids the need for the DPT to be looked up in some cases.

In all other instances (e.g. when the privilege level is 2 or 3), the most restrictive permission takes precedence. Hence, if either the privilege level or the permission level is 2 (private), the access is treated as private to a given software context regardless of whether the other of the privilege/permission level is 3.

It will be appreciated that this is just one possible way of defining permission levels in the DPT 220 and DCT 250 and other types of permission could also be defined. Also, as indicated in FIG. 8, within the combined permissions indicated in FIG. 9, these may be further qualified using the R/W/E field 835 shown in FIG. 8 which indicates whether, for a region allowed to be accessed using a translated access request, that permission applies to reads (R), writes (W) and/or instruction fetches (Execute-E) respectively.

The device permission table may be implemented as a multi-level table in memory, with table walk circuitry being provided to look up permissions defined in the table. FIG. 10 shows how a physical address 1005 may be used to lookup an entry in a multi-level DPT. As shown in FIG. 10, part of the physical address is used as a level-0 index 1010, which can be combined with a DPT base address 1015 (e.g. configured in a register of the SMMU 242) to identify an entry in a level 0 table 1020. Each entry the level 0 table corresponds to a block of memory, and stores a base address indicative of a corresponding level 1 table 1025 for that block of memory. A separate level 1 table is defined for each block of addresses, and the base address in each entry in the level 0 table 1020 identifies the table. Some entries of the level 0 table may also define a permission level for the entire block of memory; if this is the case, then the table walk circuitry need not continue the walk, since a permission level defined in a level 0 table entry is applicable to all addresses within that block.

Once a base address of a level 1 table has been obtained from the level 0 table, a level 1 index 1030 derived from the physical address is used in combination with this base address to identify a level 1 table entry. Each entry of the level 1 table 1025 corresponds to a subset of the memory addresses covered by the table, and defines, for that subset, a permission level. For example, each level 1 table entry may include the fields shown in the device permission table 220 illustrated in FIG. 7.

Moreover, in this particular example, each entry 1035 in the level 1 table is capable of specifying separate access permissions for separate address ranges. Hence, a GPI index 1040 is also derived from the physical address, to identify a particular access permission in the level 1 entry 1035. For example, if the size of one DPT entry is smaller than a single cache line (a basic unit of memory access used to transfer data between different portions of the memory system) then as multiple DPT entries may fit in one cache line, the GPI index 1040 portion of the physical address can be used to select the relevant DPT entry from that cache line. In other examples, if the DPT entry size is the full cache line, then there may be no need for a GPI index portion 1040.

In this particular example, the physical address is 52 bits long, but the upper bits 1050 are not used to identify a location in memory (e.g. they may all be set to 0, or all set to 1), and are also not used in the DPT lookup. Similarly, the lowest bits 1055 are also not used in the DPT lookup, as they indicate individual addresses within the region that corresponds to a single DPT entry.

It should be appreciated that, while the DPT is illustrated in FIG. 10 as a 2-level table, it is also possible for the table to include any number of levels. It may be useful for the number of levels of the DPT structure to be less than the number of levels supported for a multi-level page table structure used for address translation by the address translation circuitry 116. For example, a 2-level DPT may be used, and a 4-level page table structure may be used for a given stage of address translation. This may reflect that the page table structure may define address mappings and permissions to control handling of non-translated memory accesses at a finer granularity than the permissions defined in the DPT to control use of translated memory accesses.

In some examples, the access permission in the DPT may be dependent on the operating state of the software context issuing a request—for example, a separate DPT may be defined for each operating state of a plurality of operating states. FIG. 11 shows an example where separate tables are defined for software contexts executing in a secure state—e.g. secure DPT 1105—and software contexts executing in a non-secure state—e.g. non-secure DPT 1110. Note that the label “non-secure” for non-secure DPT 1110 does not necessarily indicate that the table itself is not secure—this label merely indicates that this is the table to be used for software contexts operating in the non-secure (e.g. a less-secure) state. Moreover, as shown in FIG. 11, further permission tables may also be defined for other security states.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
address translation circuitry configured to translate, in response to an advance address translation request issued by a requester device on behalf of a given software context and specifying a given virtual address, the given virtual address into a given physical address and to provide the given physical address to the requester device to be associated with a subsequent translated access request issued by the requester device; and
translated access control circuitry responsive to a translated access request issued by the requester device on behalf of the given software context and specifying a target physical address, to:
look up, based on the target physical address, corresponding permissions information indicative of corresponding access permissions defined in a device permission table for a region of physical address space encompassing the target physical address, wherein the corresponding access permissions provide information for checking whether translated access requests from a plurality of software contexts are prohibited;
determine, based on the corresponding permissions information, whether the given software context is prohibited from accessing a target memory location corresponding to the target physical address in response to translated access requests; and
when it is determined that the given software context is prohibited from accessing the target memory location in response to translated access requests, trigger an error response.

2. The apparatus of claim 1, wherein
the translated access control circuitry is configured to support at least one encoding of an entry of the device permissions table that identifies at least one access permission associated with an identified software context specified from among a plurality of software contexts by the entry of the device permissions table.

3. The apparatus of claim 1, wherein
the translated access control circuitry is configured to support the device permission table comprising a plurality of entries indexed by physical address, wherein each of the plurality of entries is shared between the plurality of contexts and identifies an access permission for an associated region of physical address space.

4. The apparatus of claim 3, wherein:
the access permission comprises a device permission level selected from a plurality of device permission levels; and
the at least one permission level comprises at least one of:
a private permission level identifying an identified software context of the plurality of software contexts and indicating that translated access requests associated with processes other than the identified software context are prohibited from accessing the associated region of physical address space; and
a shared permission level identifying an identified software context of the plurality of software contexts and indicating that translated access requests associated with processes other than the identified software context and a supervisor process operating at a higher privilege level than plurality of software contexts are prohibited from accessing the associated region of physical address space.

5. The apparatus of claim 1, wherein:
the translated access control circuitry is configured to look up, based on a device identifier specified in the translated access request, corresponding device configuration information indicative of the given software context associated with the device identifier; and
when the corresponding permissions information specifies said at least one access permission associated with the identified software context, the translated access control circuitry is configured to determine whether the given software context is prohibited from accessing the target memory location in response to translated access requests based on a comparison of the given software context and the identified software context.

6. The apparatus of claim 5 wherein
the translated access control circuitry is configured to support the device configuration table comprising a plurality of entries indexed by device identifier, wherein each of the plurality of entries identifies device configuration information for an associated device.

7. The apparatus of claim 6, wherein:
the device configuration information in each of the plurality of entries comprises privilege information indicating whether the associated device is prohibited from issuing translated access requests;
the privilege information comprises a privilege level selected from a plurality of privilege levels; and
the plurality of privilege levels include at least one privilege level indicating that the associated device is permitted to issue translated access requests even when the device permission table indicates that access to a subset of physical address space in response to translated access requests is prohibited for the at least one software context associated with the device identifier.

8. The apparatus of claim 1, comprising
a device permission cache configured to store permissions information corresponding to a subset of access permissions defined in the device permission table,
wherein the translated access control circuitry is responsive to the translated access request to look up, based on the target physical address of the translated access request, the corresponding permissions information in the device permission cache.

9. The apparatus of claim 8, wherein
the translated access control circuitry is responsive to the advance address translation request to determine the corresponding permissions information for the region of physical address space encompassing the target physical address, and to store the corresponding permissions information to the device permission cache.

10. The apparatus of claim 8, wherein:
the address translation circuitry is configured to look up, in response to the advance address translation request, a set of translation table permissions defined in an address translation table entry corresponding to the given virtual address and the given software context; and
the translated access control circuitry is configured to determine the corresponding permissions information in dependence on the translation table permissions, and to store the corresponding permissions information to the device permission cache.

11. The apparatus of claim 10, wherein
the translated access control circuitry is responsive to determining, based on the translation table permissions, that at least one of the corresponding access permissions for the given physical address is unknown from the translation table permissions, to set, as the corresponding permissions information to be stored to the device permission cache, a default access permission.

12. The apparatus of claim 1, comprising
device permission table walk circuitry configured to look up a multi-level table representing the device permission table,
wherein:
each level of the multi-level table comprises entries associated with successively smaller regions of the physical address space;
a final level of the multi-level page table defines the access permissions; and
each level other than the final level defines pointers to a plurality of tables in the next level, the pointers being selectable based on a portion of a physical address.

13. The apparatus of claim 12, wherein at least one of:
an upper limit of a number of levels of the multi-level table supported by the device permission table walk circuitry is less than an upper limit of the number of levels of page tables supported by page table walk circuitry; and
the device permission table walk circuitry is configured to support at least one encoding of an entry of at least one level other than the final level indicating an access permission that applies to an entire block of physical address space covered by that entry at said at least one level other than the final level.

14. (canceled)

15. The apparatus of claim 1, comprising
a device permission cache configured to store permissions information corresponding to a subset of access permissions defined in the device permission table,
wherein the translated access control circuitry is configured to support at least one encoding of an entry of the device permissions table indicating that access permissions for each of a plurality of regions of physical address space are identical and can be represented by a single entry in the device permission cache corresponding to a predetermined one of the plurality of regions.

16. The apparatus of claim 1, wherein:
the translated access request is associated with a security state selected from amongst a plurality of possible security states; and
the lookup of the corresponding permissions information is based on the security state and the target physical address.

17. The apparatus of claim 15, wherein
the translated access control circuitry is configured to support a plurality of device permission tables, each corresponding to a different security state.

18. The apparatus of claim 1, wherein
the translated access control circuitry is configured to support, as the device permission table, a table shared between a plurality of devices to define access permissions for translated accesses issued by the plurality of devices.

19. The apparatus of claim 1, comprising:
a device permission cache configured to store permissions information corresponding to a subset of access permissions defined in the device permission table;
processing circuitry configured to execute software; and
device permission cache control circuitry configured to invalidate entries in the device permissions cache in response to a device permission cache maintenance command triggered by the software executing on the processing circuitry and having a different encoding to a translation look-aside buffer invalidation command for triggering invalidation of page table information from a translation look-aside buffer.

20. A method comprising:
in response to an advance address translation request issued by a requester device on behalf of a given software context and specifying a given virtual address, translating the given virtual address into a given physical address and providing the given physical address to the requester device to be associated with a subsequent translated access request issued by the requester device; and
in response to a translated access request, issued by the requester device on behalf of the given software context and specifying a target physical address, translated access control circuitry performing steps of:
looking up, based on the target physical address, corresponding permissions information indicative of corresponding access permissions defined in a device permissions table for a region of physical address space encompassing the target physical address, wherein the corresponding access permissions provide information for checking whether translated access requests from a plurality of software contexts are prohibited;
determining, based on the corresponding permissions information, whether the given software context is prohibited from accessing a target memory location corresponding to the target physical address in response to translated access requests; and
when it is determined that the given software context is prohibited from accessing the target memory location in response to translated access requests, triggering an error response.

21. A computer-readable medium to store computer-readable code for fabrication of an apparatus comprising:
address translation circuitry configured to translate, in response to an advance address translation request issued by a requester device on behalf of a given software context and specifying a given virtual address, the given virtual address into a given physical address and to provide the given physical address to the requester device to be associated with a subsequent translated access request issued by the requester device; and
translated access control circuitry responsive to a translated access request issued by the requester device on behalf of the given software context and specifying a target physical address, to:
look up, based on the target physical address, corresponding permissions information indicative of corresponding access permissions defined in a device permission table for a region of physical address space encompassing the target physical address, wherein the corresponding access permissions provide information for checking whether translated access requests from a plurality of software contexts are prohibited;
determine, based on the corresponding permissions information, whether the given software context is prohibited from accessing a target memory location corresponding to the target physical address in response to translated access requests; and
when it is determined that the given software context is prohibited from accessing the target memory location in response to translated access requests, trigger an error response.
